(19) United States
(12) Patent Application Publication
(10) Pub. No.: US 2012/0085240 A1
(43) Pub. Date: Apr. 12, 2012

(54) SCRUBBER TOWER AND RELATED FLUE GAS SCRUBBING DEVICE

(75) Inventor: Aat Pelkman, Kamen (DE)

(73) Assignee: AE & E LENTJES GMBH, Ratingen (DE)

(21) Appl. No.: 13/375,161

(22) PCT Filed: Mar. 20, 2010
(86) PCT No.: PCT/EP2010/001767

§ 371 Date: Dec. 19, 2011

(30) Foreign Application Priority Data
Jun. 5, 2009 (EP) 09 007 453.5

(51) Int. Cl. B01D 47/06

(52) U.S. Cl. 96/355; 261/127

(57) ABSTRACT

The invention relates to a scrubber tower of a flue gas purification device as well as a flue gas purification device including a corresponding scrubber tower.

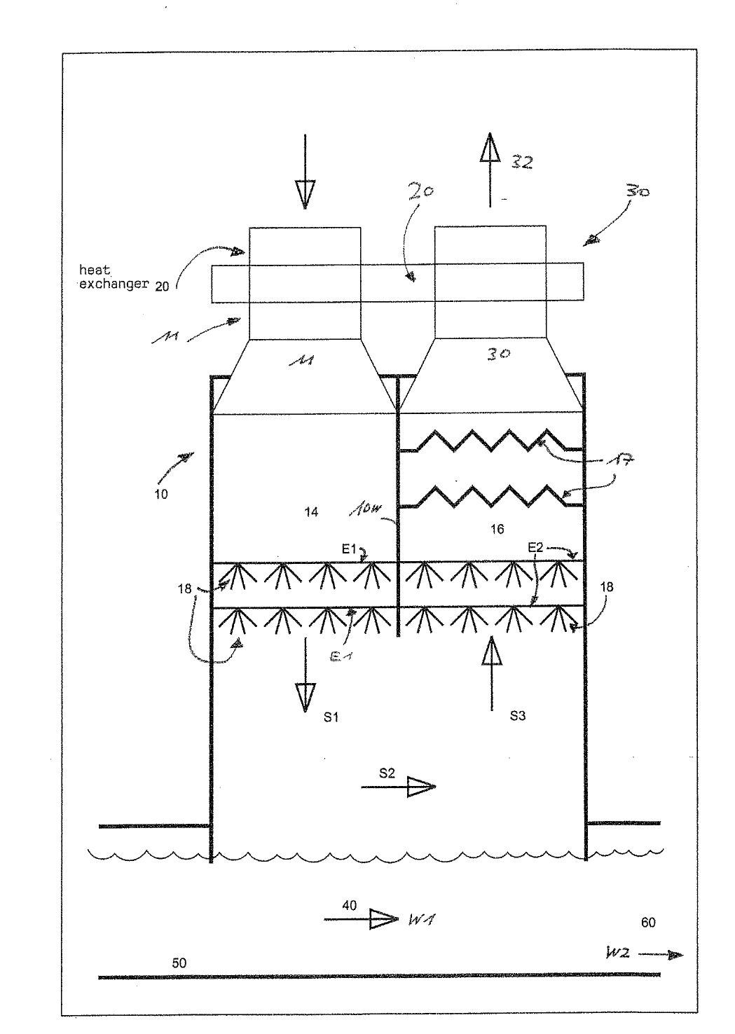

The invention relates to a scrubber tower of a flue gas purification device as well as a flue gas purification device including a corresponding scrubber tower.

The invention particularly relates to a scrubber tower or a flue gas purification device respectively using seawater as an absorbent. The invention includes devices using other basic absorbents, for example lime milk. As for simplicity prior art and the invention will be described hereinafter with respect to devices using seawater as an absorbent fluid. Known scrubbing devices are basically constructed as follows:

Flue gas, which may derive from a power station, is introduced at the lower part of the scrubbing tower into the scrubbing tower and further guided upwardly to a flue gas exit. Along this way through the scrubber tower the flue gas is contacted with the fluid absorbent in counter flow. For this purpose typically nozzles are arranged in various levels of the scrubbing tower, by which the absorbent is sprayed as fine particles to provide a preferably large reaction surface with the flue gas to be purified.

The fluid absorbent (scrubbing fluid), which may particularly comprise seawater, comprises ingredients, which, i. a., absorb sulfur oxides from the flue gas or chemically react with these sulfur oxides. Such a purification device is for example known from DE 10058548 A1.

Starting from the demand to continuously improve prior art the invention is based on the object to provide a possibility how a flue gas purification device may be optimized with respect to construction and/or absorption and/or processing parameters.

Against this background the main aspects of the invention may be summarized as follows:

Instead of a unidirectional absorption path a multipart absorption path is arranged within the scrubbing tower. While according to prior art the flue gas is basically flowing in one direction from A to B (flue gas in counter flow to the flow of scrubbing fluid) a multipart absorption path according to the invention is characterized in that the flue gas is flowing along at least one section in one direction and along at least one further section in another, especially opposed direction through the scrubbing tower.

Against the background that the fluid (seawater) brought into contact/reaction with the flue gas, generally has a unidirectional flow direction (vertically from top to bottom) following gravity (gravitation) it derives that the flue gas to be purified is contacted with the absorbent along at least one part of the absorption path in cocurrent flow and along at least one further section of the absorption path in counter flow.

Starting from a defined height of the scrubber tower the described meander-like guidance of the flue gas allows a longer transport way of the flue gas through the scrubber tower and insofar longer reaction times and a more effective flue gas purification.

A further aspect of the invention is to use the new flue gas flow through the scrubber tower to install a heat exchanger directly at the scrubber tower or to integrate it into the scrubber tower in order to bring the flue gas introduced into the scrubbing tower in contact with the flue gas taken off the scrubber tower and to use the corresponding thermal energy during processing. In other words: The typically relatively warm/hot flue gas (for example 150°-300° C.) is cooled down in the heat exchanger (namely by the purified, returned flue gas) before contacting the absorbent, for example by >50° C. or >80° C. or >100° C. Insofar the fluid absorbent (based on seawater) brought into contact with the flue gas is not that much heated up as compared the devices according to prior art. This has procedural advantages with respect to further treatment of the absorbent before return to sea.

According to the invention the purified flue gas, which has a much lower temperature compared with the introduced flue gas, is heated up again by the heat exchanger before discharging into the environment. In other words: During introduction of the flue gas into the scrubber tower heat is extracted from the flue gas which is then at least partially given back to the flue gas before its discharge into the atmosphere.

Accordingly the invention relates in its most general embodiment to a scrubber tower of a flue gas purification device having the following features:

A flue gas inlet into the scrubber tower,

a flue gas outlet out of the scrubber tower,

flue gas inlet and flue gas outlet are fluidly connected (connected to form a flow),

a multipart absorption path (absorption section) for the flue gas between the flue gas inlet and flue gas outlet, wherein the flue gas is conducted along at least one part (section) of the absorption path (section) in the same flow (cocurrent flow) and along at least one further part (section) of the absorption path (section) in a counter flow to the absorbent supplied,

at least one heat exchanger for heat transfer between the flue gas supplied to the scrubber tower and the flue gas extracted from the scrubber tower.

For example the absorbent is an absorbent based on sea water.

Typically the scrubber tower, as it says, has the shape of a tower or a chimney with a large cross-section. Basically the cross-section is arbitrarily. In connection with the partition of the absorption path in sections, along which the flue gas in guided in a cocurrent flow with the absorbent and in which the flue gas in flowing in counter current flow to the absorbent a basically rectangular, horizontal cross-section of the scrubber tower is advantageous in view of constructural and processing reasons.

This is true as well with respect to the defined section of the absorption path, which may at least sectionally provide a rectangular (square) cross-section. Such a rectangular cross-section allows to install nozzle levels for the fluid absorbent allowing a continuous (statistic) distribution of spraying nozzles or other fluid distributors over the total cross-section and insofar to avoid dead spots or the like. At the same time the contact between flue gas and absorbent is optimized. Furthermore, a rectangular tower is principally is easier to construct compared with a circular or oval tower.

In the easiest case flue gas inlet and flue gas outlet are arranged at the upper end of the scrubber tower, that means, flue gas in introduced from above into the scrubber tower, then fed downwardly within the scrubber tower, further redirected and finally guided in an opposed direction upwardly again in order to finally being discharged at the upper end of the scrubber tower. The construction of the absorption path may be such that a redirection of the flue gas flow within the scrubber is realized once or several times.

In such an embodiment it may be advantageous to arrange the heat exchanger as well at the upper end of the scrubber tower, for example such that the heat exchanger provides a link between flue gas inlet and flue gas outlet. This allows a particularly compact construction of the heat exchanger and the heat exchanger forms the upper part of the scrubber tower or is arranged directly onto the upper end onto the scrubber tower. Insofar the flue gas may be introduced directly via a corresponding feeding line along said heat exchanger into the scrubber tower and redirected along the absorption path via the heat exchanger and an associated chimney into the surrounding.

With respect to the introduction of the fluid absorbent the construction of the absorption section may be in principle realized according to prior art, that means for example by the spray levels with spray nozzles as already mentioned.

The construction of the absorption section is decisive for the inventive device in view of the flow of the flue gas and thus implicitly for the current flow of the flue gas with respect to the absorbent.

This inventive task may be realized in a most simply case by the dividing the absorption section along the scrubber tower into parts. In case of a scrubber tower with rectangular horizontal cross-section this rectangular area is divided into two basically equal sections, wherein the flue gas is flowing downwardly along one section and upwardly along the other section. Both parts of the absorption section are totally or at least partially running parallel to each other.

In connection with the heat exchanger and the described advantages in processing one embodiment of the invention provides that one part of the absorption section extends vertically downwardly from the heat exchanger and the further part of the absorption section extends vertically upwardly toward the heat exchanger.

To collect the absorbent and to further process it, if necessary, a sump for said absorbent may be provided below the absorption section. Such a fluid sump is present as well with known scrubbers. Compared with known scrubbers an important difference is that the fluid sump receives the absorbent from at least two parts of the absorption section, namely at least one part along which the gas is flowing cocurrently with the absorbent and at least one part in which the flue gas in flowing in counter current to the absorbent which generally flows from up to down.

With the adsorption path mentioned with two sections mostly running vertically and parallel to each other the flue gas may be fed at the end of one section into an area which extends over the whole cross-section of the scrubber tower before it is reguided along the further part of the absorption path. This redirection area (space) for the flue gas is arranged above the fluid sump. The absorbent thus freely falls into the fluid sump.

The scrubber tower as described allows to construct the fluid sump and/or the heat exchanger as part of the scrubber tower or to arrange the heat exchanger directly above the scrubber tower and/or to arrange the fluid sump directly below the scrubber tower.

Here again the rectangular cross-section of the scrubber tower provides advantages insofar as the rectangular cross-section may be realized as well for the fluid sump. This is important in view of the addition of fresh seawater into the area of the fluid sump (from one direction) or the extraction of the absorbent from the fluid sump (in the same direction) as the flow direction of said fresh seawater into subsequent parts of the device such as an aeration basin for said absorbent or the mixture of absorbent and fresh seawater respectively.

In this case all parts can be part of a common channel system which extends in front of, below and after the scrubber.

The point is to increase pH-value of the sea water after contact with the flue gas to a value of about 8 (similar to the pH-value of fresh seawater) before the seawater is released into the sea. This can be achieved by the addition of fresh seawater into the area of the fluid sump.

Basically this is known and is therefore not further described here at it is not important for the general construction of the new scrubber tower or its integration into a flue gas purification device.

The invention further relates to a flue gas purification device including the scrubber tower of the type mentioned.

Further features of the invention derive from the features of the sub claims as well as the other application documents.

The invention will now be described with respect to one embodiment in more detail. The only figure shows in a schematic presentation a vertical cross-section of a scrubber tower according to the invention. The corresponding description comprises features of general validity which may be realized as well in other embodiments of the scrubber tower or in a corresponding flue gas purification unit.

The scrubber tower 10 represented in the figure has a rectangular horizontal cross-section which is divided by an intermediate wall 10b into basically equal parts (sections) so that two parts 14, 16 of an absorption path are realized parallel to each other within the scrubber tower 10 and along which a flue gas to be purified is guided through the scrubber tower.

The introduction of the flue gas into part 14 (flue gas inlet 11) is achieved from above, wherein the hot (here: expected 180° C. flue gas) is first guided through a heat exchanger 20 by which the temperature of the flue gas cools down (here to an expected about 120° C.). The flue gas is further guided vertically downwardly (arrow S1) along part 14 by corresponding, non shown ventilators, where it is brought into contact with an absorbent, based on sea water, which is fed in via spraying nozzles 18 in a cocurrent flow with the flue gas. During this the flue gas is further cooled, in an extreme case down to the temperature of the absorbent.

The spray nozzles 18 are arranged along different levels E1 (at a vertical distance) along the cross-section of part 14 of the absorption path.

At the lower end of part 14 the flue gas is redirected in the direction of arrow S2 and then flows through part 16 of said absorption path upwardly (arrow S3). In said section 16 there are arranged again spraying levels E2 with spraying nozzles 18 whereby contact between flue gas and absorbent is achieved here in a counter flow.

In the following the flue gas stream is guided through a double-stage droplet separator 17 so that a basically dry flue gas enters heat exchanger 20.

At the upper end of section 16 (flue gas outlet 30) the flue gas is finally guided through said heat exchanger 20 into a chimney 32 and from there it discharges into the atmosphere.

While the cooled flue gas is for example heated to 80° C. before discharging into the atmosphere the flue gas getting in contact with the absorbent has a characteristically lower temperature compared with prior art devices without heat exchanger, caused by the previous cooling in said heat exchanger 20. This is the point why said absorbent is heated characteristically less before entering the fluid sump at the lower end of the scrubber tower 10.

The channel 50, which extends from an area left of said scrubber tower to an area right of said scrubber tower, includes the fluid sump in between.

Feeding of fresh sea water is achieved from left (arrow W1) such that within the fluid sump 40 it becomes possible to increase the pH of the used sea water from—for example—4,5 to 6 before the seawater is introduced into an aeration basis which is schematically represented by numeral 60. At this place sulfide components of the fluid are oxidized to sulfate before the seawater is discharged into the sea (arrow W2).

The device according to the invention presents a compact construction. It enables long holding times of the flue gas in the scrubber tower and insofar long reaction times and favorite absorption values.

The rectangular cross-section of the scrubber tower may be extended town into the base (foundation). This gives the scrubber tower a high stability and enables it in a particular advantageous manner to integrate the said fluid sump into a channel system below the scrubber tower or within the lower part of the scrubber tower respectively.

By use of the heat exchanger the temperature of the flue gas to be treated may be lowered characteristically and insofar a non-desired heating of the absorbent may be avoided.

1. A scrubber tower of a flue gas purification device having the following features:
1.1 a flue gas inlet (11) into the scrubber tower (10),
1.2 a flue gas outlet (30) out of the scrubber tower (10),
1.3 flue gas inlet (11) and flue gas outlet (30) being connected to form a flow,
1.4 a multipart absorption section for the flue gas between flue gas inlet (11) and flue gas outlet (30), wherein
1.5 the flue gas is conducted along at least one part (14) of the absorption section in the same flow as a supplied absorbent and along at least one further part (16) of the absorption section in counter flow to a supplied absorbent,
1.6 at least one heat exchanger (20) for heat transfer between the flue gas supplied to the scrubber tower (10) and the flue gas exhausted from the scrubber tower (10).

2. The scrubber tower according to claim 1, wherein the flue gas inlet (11), the flue gas outlet (30), or both are situated at the upper end of the scrubber tower (10).

3. The scrubber tower according to claim 1, wherein the heat exchanger (20) is situated at the upper end of the scrubber tower (10).

4. The scrubber tower according to claim 1, wherein the heat exchanger (20) connects flue gas inlet (11) and flue gas outlet (30).

5. The scrubber tower according to claim 1, wherein spray nozzles (18) for supplying the absorbent are situated along the absorption section.

6. The scrubber tower according to claim 1, wherein at least two parts (14, 16) of the absorption section run parallel to one another.

7. The scrubber tower according to claim 1, wherein one part (14) of the absorption section extends vertically downward from the heat exchanger (20) and the further part (16) of the absorption section runs vertically upward towards the heat exchanger (20).

8. The scrubber tower according to claim 1, having a liquid sump (40) for the absorbent situated below the absorption section (14, 16).

9. The scrubber tower according to claim 8, wherein at least two parts (14, 16) of the absorption section are connected to form a flow via a chamber implemented above the liquid sump.

10. The scrubber tower according to claim 8, whose liquid sump (40) is situated along a liquid duct (50).

11. The scrubber tower according to claim 1, having an essentially rectangular horizontal cross-section.

12. The scrubber tower according to claim 1, whose absorption section (14, 16) at least sectionally has a rectangular horizontal cross-section.

13. The scrubber tower according to claim 1, having a droplet separator (17).

14. The scrubber tower according to claim 13, whose droplet separator (17) is situated in the flow at the end of the absorption section (16) operating in counter flow.
